(19) United States
(12) Patent Application Publication
(10) Pub. No.: US 2024/0367462 A1
(43) Pub. Date: Nov. 7, 2024

(54) Heavy Goods Vehicle Tire with Complex Tread Pattern

(71) Applicant: COMPAGNIE GENERAL DES ETABLISSEMENTS MICHELIN, Clermont-Ferrand (FR)

(72) Inventors: Fabien MARLIER, Clermont-Ferrand Cedex 9 (FR); Tony ZIVKOVIC, Clermont-Ferrand Cedex 9 (FR)

(21) Appl. No.: 18/565,381

(22) PCT Filed: May 23, 2022
(86) PCT No.: PCT/FR2022/050975

§ 371 Date: Nov. 29, 2023

(30) Foreign Application Priority Data
May 31, 2021 (FR) FR2105689

(51) Int. Cl. B60C 11/03; B60C 11/04

(52) U.S. Cl. CPC B60C 11/0323; B60C 11/045; B60C 2200/06

(57) ABSTRACT

A heavy-duty vehicle tire with complex tread pattern, and is intended to improve the resistance to irregular wear of the tread thereof. The tire (1) has a tread (2) with at least one circumferential complex cut (6) formed by an alternation of external cavities (7) and internal cavities (8), each external cavity (7) having a length (L1), wherein the length (L1) of each external cavity (7) is equal to at least 1.5% and at most 12% of the external diameter (D) of the tire (1), as measured on the tire when new and free.

The present invention relates to a tire for a heavy-duty vehicle, and more specifically to the tread thereof, comprising complex cuts opening discontinuously, at regular or irregular intervals, on the tread surface of the tire when new.

A tread, constituted by at least one rubber-based material, is the wearing part of the tire, situated at the periphery thereof and intended to be worn away when in contact with the ground via a tread surface. The tread usually comprises a tread pattern, which is a combination of cuts, or voids, and raised elements in the form of blocks or ribs, and is intended primarily to ensure satisfactory performance in terms of grip, more particularly on a wet roadway.

The geometric features described in this document are provided in a cylindrical frame of reference related to the tire. By convention, the circumferential or longitudinal direction is the direction of rotation of the tire, the axial or transverse direction is the direction parallel to the axis of rotation of the tire, and the radial direction is a direction perpendicular to the axis of rotation of the tire.

Each cut has a midline that is not necessarily straight and that may be wavy or zigzag, with a circumferential, transverse or oblique mean direction. By convention, a cut is deemed to be circumferential where the mean direction of the midline thereof is circumferential, i.e. forming a mean angle of less than 30° with the circumferential direction. A cut is deemed to be transverse where the mean direction of the midline thereof is transverse, i.e. forming a mean angle of at least 60° with the circumferential direction. A cut is deemed to be oblique where the mean direction of the midline thereof is oblique, i.e. forming a mean angle of between 30° and 60° with the circumferential direction.

As is known, the wet-weather running conditions of a vehicle, and more particularly those of a heavy-duty vehicle, require rapid evacuation of the water present in the contact patch between the tread and the roadway. This evacuation makes it possible to ensure that the material constituting the tread comes into direct contact with this roadway via the tread surface. The water that is not pushed ahead of or to the sides of the tire flows or is collected partially in the cuts formed in the tread.

The evacuation of the water is ensured by the cuts, which form a fluid flow network that needs to be effective throughout the service life of the tire, from new to a state of maximum wear. The state of maximum wear, which is set by the regulations in force, is the state of wear beyond which the tire needs to be removed from the vehicle for safety reasons.

The cuts allowing the evacuation of water are usually essentially wide cuts called grooves. A groove has a width such that the facing walls of material that delimit the groove do not come into contact with one another when the tread enters the contact patch, when the tire is subjected to recommended inflation and load conditions as are defined in particular by the European standards of the “European Tire and Rim Technical Organization” or “E.T.R.T.O.” in its “Standards Manual 2020—Commercial Vehicle Tires”. The deformations in compression and in shear of the raised elements delimiting the groove govern the pressures in the contact patch, and therefore wear. In addition, these deformations, by generating hysteresis losses in the material of the tread, impact the rolling resistance, and therefore the fuel consumption of the vehicle.

A tread may also comprise narrow cuts or sipes. A sipe has a width such that the facing walls of material that delimit the sipe come into contact with one another at least partially when the tread enters the contact patch, under the tire load and pressure conditions specified by the E.T.R.T.O. and set out above. A sipe does not make it possible to evacuate the water, but, with respect to the grip, has an edge corner effect in the contact patch, which makes it possible in particular to break a film of water that may be present on the ground.

To limit the reduction in the volume of material to be worn away of the tread that results from the presence of grooves and sipes, complex cuts have been proposed, which make it possible, compared with normal cuts, which are completely open onto the tread surface, to increase the volume of material of the tread while complying with the void volume for storage of water above a given threshold, regardless of the level of wear of the tire.

Treads comprising such complex cuts have been described in particular in the documents WO 2011039194, WO 2011101495, WO 2012130735, WO 2016188956, WO 2019008276 and WO 2019122677. A complex cut opens onto the tread surface in a discontinuous manner, at regular or irregular intervals, when new. Each complex cut has external cavities, which open onto the tread surface and are separated from one another in the main direction of the complex cut. The main direction of the complex cut is usually but not necessarily the direction in which water flows in said cut when running on ground covered in water. This complex cut comprises, besides the external cavities, internal cavities formed inside the tread and generally connected to the tread surface by sipes. These internal cavities are positioned radially and entirely on the inside of the tread surface in the new state, and are interposed between the external cavities. The internal cavities may be positioned at different depth levels in the thickness of the tread. Furthermore, the continuity of the flow of water in each complex cut, in the new state, is usually ensured by connecting portions, or connecting channels, between two consecutive cavities, respectively an external cavity and an internal cavity. The assembly constituted by the external cavities, the internal cavities and the connecting channels thus forms a continuous groove. By contrast, the juxtaposition of internal and external cavities that are not connected to each other and therefore do not allow fluid to flow from one to the other about the entire circumference of the tire does not constitute a continuous groove, and is therefore not considered to be a complex groove.

The volume of all of the internal cavities, external cavities and connecting channels in a tread with complex cuts is less than the volume of all of the grooves in a normal tread that are fully open on the tread surface when new, with a depth equal to the maximum depth of the internal or external cavities. The presence of complex cuts thus makes it possible to limit the reduction in stiffness of the tread in the new state that is associated with the presence of the grooves.

A tread pattern may have both complex cuts, opening intermittently onto the tread surface, and conventional grooves, opening onto the tread surface along the entire length thereof.

It has been noted that heavy-vehicle tire treads with circumferential complex cuts positioned axially near to the edges of the tread are subject to irregular wave-shaped wear patterns through the width and depth of the tread. These irregular wear patterns generate vibrations when the vehicle is in motion that could adversely affect comfort, notably in tires mounted on the steering axle at the front of the vehicle. This reduced driving comfort results in early replacement of the tires, before the tires are fully worn, which results in an economic loss for carriers.

Consequently, the invention is intended to improve the resistance against irregular wear of a tire tread for a heavy-duty vehicle, comprising circumferential complex cuts with alternating external cavities, internal cavities and connecting channels between external cavities and internal cavities, i.e. to delay the appearance of irregular wear patterns on said tread for as long as possible.

This objective has been achieved by a heavy-duty vehicle tire comprising a tread intended to come into contact with the ground via a tread surface, comprising cuts delimiting raised elements,
at least one cut being a circumferential complex cut with a midline extending in a circumferential direction of the tire, and comprising, when the tire is new, an alternation of external cavities opening onto the tread surface and internal cavities not opening onto the tread surface, two consecutive cavities, respectively an external cavity and an internal cavity, being connected to each other by a connecting channel,
each external cavity having a length measured along the midline on the tread surface of the tire when new and free,
the length of each external cavity being equal to at least 1.5% and at most 12% of the external diameter of the tire, as measured on the tire when new and free.

To delay the appearance of irregular wear patterns caused by a circumferential complex cut of a tread for as long as possible; said circumferential complex cut comprising, when the tire is new, an alternation of external cavities and internal cavities, two consecutive cavities, respectively an external cavity and an internal cavity, being connected to each other by a connecting channel; it has been demonstrated that the length of each external cavity measured on the tread surface of the tire when new and free should have a relative value of between 1.5% and 12% of the external diameter of the tire, as measured on the tire when new and free. The length of the external cavity and the external diameter of the tire are measured when the tire is new, i.e. unworn, and free, i.e. not mounted on a rim and not inflated.

Indeed, the alternation of external cavities and internal cavities in a circumferential complex cut causes the stiffness values in the thickness of the tread to vary along said circumferential cut, thereby causing pressure variations and slipping in the contact between the tread and the ground, which causes the appearance of irregular wear patterns.

The range of values of the ratio between the external cavity length and the external diameter of the tire thus ensures more uniform wear, i.e. with no irregular wear patterns generated by the alternation of internal and external cavities.

The length of each external cavity is preferably equal to at most 10% of the external diameter of the tire. Below this value, the variation in stiffness caused by alternation of the external cavities and internal cavities is particularly optimized.

Advantageously, the tire having a tread surface portion in contact with flat ground of average length when the new tire is mounted on a recommended rim, inflated to a recommended pressure and subjected to a recommended vertical load, the recommended rim, pressure and vertical load being as defined by the European standards of the European Tire and Rim Technical Organization, the length of each external cavity is equal to at least 5% and at most 55% of the mean length of the tread surface portion in contact with the ground. The range of values [5% to 55%] of the ratio between the external cavity length and the mean length of the contact patch of the tire with the ground, under standardized usage conditions, guarantees satisfactory grip performance on wet ground.

The length of each external cavity is preferably equal to at most 45% of the mean length of the tread surface portion in contact with the ground.

Advantageously, each internal cavity having a length measured along the midline on a radially external section of said internal cavity, the length of each external cavity is equal to at least 70% and at most 130% of the length of each internal cavity. To maximize wear uniformity and grip efficiency on wet ground using the water storage capacity of the internal cavities of the tread, the open volume of the external cavities and the concealed volume of the internal cavities, i.e. the internal and external cavity lengths, must be evenly distributed.

Advantageously, each external cavity having a transverse surface perpendicular to the midline, and each internal cavity having a transverse surface perpendicular to the midline, the transverse surface of each external cavity is equal to at least 50% and at most 150% of the transverse surface of each internal cavity. These conditions enable a regular fluid flow through the alternating external cavities and internal cavities, since there are no significant bottlenecks in the complex cut when passing from an external cavity to an internal cavity.

The transverse surface of each external cavity is preferably equal to at least 80% and at most 140% of the transverse surface of each internal cavity. The even distribution of the transverse surfaces of the external cavities and the internal cavities ensures a regular fluid flow in the complex cut.

The tire when new having an axial tread width and at least one lateral circumferential complex cut, the midline of which is positioned at an axial distance from a median circumferential plane of the tire, splitting the tire into two symmetrical portions, the axial distance of the lateral circumferential complex cut is advantageously equal to at least 25% and at most 45% of the axial tread width. Such a lateral circumferential complex cut is thus positioned axially in a lateral portion of the tread. In this lateral portion, in line with such a lateral circumferential cut, the crown of the tire usually comprises only a rubber portion, since the axially external end of the crown reinforcement is usually axially inside said circumferential edge cut. Consequently, a lateral tread portion is more flexible than the central portion of the tread, which results in more slipping in the contact with the ground, and therefore more irregular wear patterns. In addition to the intrinsic variation in stiffness values caused by the alternation of external cavities and internal cavities, lateral circumferential complex cuts liable to generate local slipping are thus positioned axially in a zone with a high risk of slipping. In conclusion, such cuts are particularly liable to irregular wear patterns for these two reasons, and will therefore benefit particularly from application of the invention.

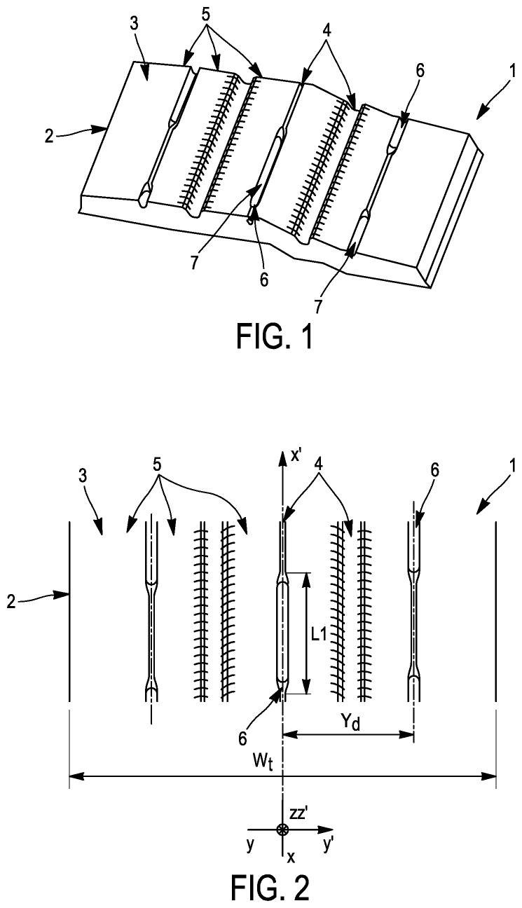

The features of the invention are illustrated by the schematic FIGS. 1, 2, 3, 4A, 4B and 4C, which are not drawn to scale.

FIG. 1: Perspective view of a tire tread according to the invention,

FIG. 2: Top view of a tire tread according to the invention,

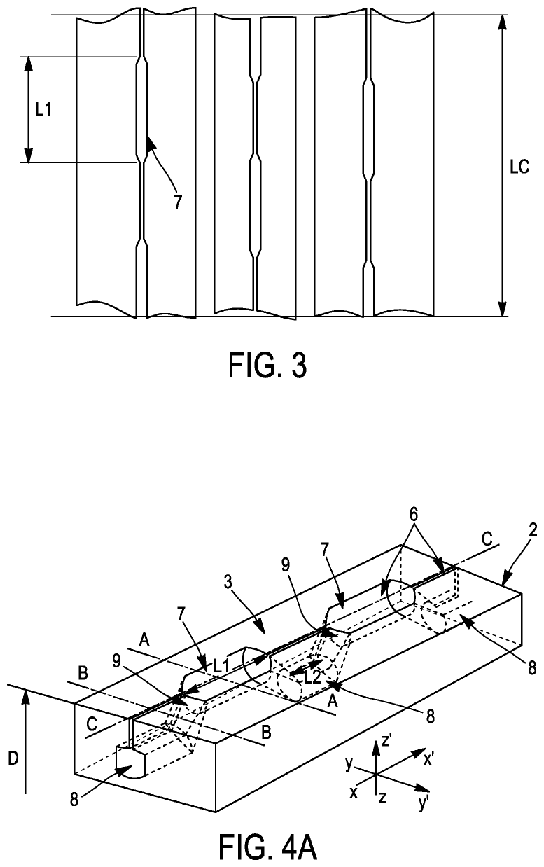

FIG. 3: Footprint of a tire tread according to the invention,

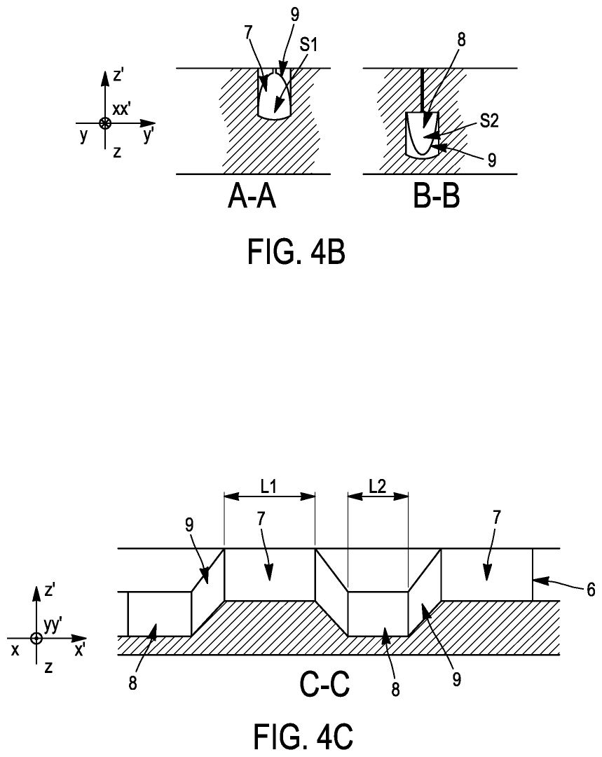

FIG. 4A: Perspective view of a circumferential complex cut portion of a tire tread according to the invention,

FIG. 4B: Respective meridian cross sections of an external cavity (A-A) and an internal cavity (B-B) of a circumferential complex cut portion of a tire tread according to the invention,

FIG. 4C: Circumferential cross section (C-C) of a circumferential complex cut portion of a tire tread according to the invention.

FIG. 1 is perspective view of a tire tread 2 according to the invention. The tread 2 of a tire 1 for a heavy-duty vehicle, intended to come into contact with the ground via a tread surface 3, comprises cuts 4 delimiting raised elements 5.

In the embodiment shown, the tread comprises three circumferential complex cuts 6, specifically a median circumferential complex cut and two lateral circumferential complex cuts, in pairs separated by a circumferential groove cut. Each circumferential complex cut 6 having a midline extending in a circumferential direction of the tire comprises, when the tire is new, an alternation of external cavities 7 opening onto the tread surface 3 and internal cavities (not shown) not opening onto the tread surface 3.

FIG. 2 is a top view of a tire tread 2 according to the invention. In FIG. 2, the tire 1 when new has an axial tread width Wt and three circumferential complex cuts 6: two lateral circumferential complex cuts 6, the respective midline of which is positioned at an axial distance Yd from a median circumferential plane XZ of the tire, splitting the tire into two symmetrical portions, and a median circumferential complex cut 6, the midline of which is positioned in the median circumferential plane XZ. Advantageously, the axial distance Yd of the lateral circumferential complex cut 6 is equal to at least 25% and at most 45% of the axial tread width Wt. Furthermore, each external cavity 7 has a length L1 measured along the midline of the corresponding circumferential complex cut 6 on the tread surface 3 of the tire when new and free.

FIG. 3 shows a footprint of a tire tread 2 according to the invention, i.e. the contact patch of a tire with flat ground when inflated and compressed. Said contact patch is a tread surface portion in contact with flat ground of mean length Lc when the new tire 1 is mounted on a recommended rim, inflated to a recommended pressure and subjected to a recommended vertical load. According to an advantageous embodiment of the invention, the length L1 of each external cavity 7 is equal to at least 5% and at most 55% of the mean length Lc of the tread surface portion in contact with the ground. Preferably, the length L1 of each external cavity 7 is equal to at most 45% of the mean length Lc of the tread surface portion in contact with the ground.

FIG. 4A is a perspective view of a circumferential complex cut portion 6 of a tire tread 2 according to the invention. The circumferential complex cut 6 having a midline extending in a circumferential direction XX′ of the tire comprises, when the tire is new, an alternation of external cavities 7 opening onto the tread surface 3 and internal cavities 8 not opening onto the tread surface 3, two consecutive cavities, respectively an external cavity 7 and an internal cavity 8, being connected to each other by a connecting channel 9. Each external cavity 7 has a length L1 measured along the midline of the circumferential complex cut 6 on the tread surface 3 of the tire when new and free. Each internal cavity 8 has a length L2 measured along the midline on a radially external section of said internal cavity 8. According to the invention, the length L1 of each external cavity 7 is equal to at least 1.5% and at most 12% of the external diameter D of the tire 1, as measured on the tire when new and free. The length L1 of each external cavity 7 is preferably equal to at most 10% of the external diameter D of the tire 1. Two meridian cross sections in a meridian plane YZ defined by the axial direction YY′ and a radial direction ZZ′ are provided respectively at an external cavity 7 (A-A) and an internal cavity 8 (B-B), and are shown in FIG. 4B. A circumferential cross section (C-C) in a circumferential plane XZ defined by the circumferential direction YY′ and a radial direction ZZ′ is provided at the midline of a circumferential complex cut portion 6 and is shown in FIG. 4C.

FIG. 4B shows two meridian cross sections of an external cavity 7 (A-A) and an internal cavity 8 (B-B) of a circumferential complex cut portion 6 of a tire tread 2 according to the invention. As described above, two consecutive cavities, respectively an external cavity 7 and an internal cavity 8, are connected to each other by a connecting channel 9. Advantageously, each external cavity 7 having a transverse surface S1 perpendicular to the midline, and each internal cavity 8 having a transverse surface S2 perpendicular to the midline, the transverse surface S1 of each external cavity 7 is equal to at least 50% and at most 150% of the transverse surface S2 of each internal cavity 8. The transverse surface S1 of each external cavity 7 is preferably equal to at least 80% and at most 140% of the transverse surface S2 of each internal cavity 8.

FIG. 4C is a circumferential cross section (C-C) of a circumferential complex cut portion 6 of a tire tread according to the invention. Advantageously, the length L1 of each external cavity 7 is equal to at least 70% and at most 130% of the length L2 of each internal cavity 8.

The invention has more specifically been studied for a tire of size 315/70R22.5 intended to be fitted to a steering axle of a heavy-duty vehicle with a load capacity of 4000 kg for an inflation pressure equal to 9 bar.

Table 1 below compares the characteristics of a tire I according to the invention and a reference tire R:

TABLE 1

| Characteristics | R | | I | |
|---|---|---|---|---|
| External diameter D of the free tire | 1007 | mm | 1007 | mm |
| Mean length of the contact patch LC | 226 | mm | 226 | mm |
| of the tire mounted, inflated and | | | | |
| compressed under the conditions | | | | |
| recommended by ETRTO (mm) | | | | |
| Length L1 of external cavity | 132 | mm | 65 | mm |
| Transverse surface S1 of external | 66 | mm² | 32 | mm² |
| cavity | | | | |
| Length L2 of internal cavity | 101 | mm | 55 | mm |
| Transverse surface S2 of internal | 53 | mm² | 27 | mm² |
| cavity | | | | |
| Ratio L1/D | 13.1% | | 6.5% | |
| L1/LC ratio | 58% | | 29% | |
| Ratio L1/L2 | 130% | | 118% | |
| Ratio S1/S2 | 125% | | 118% | |
| Width Wt of the tread | 260 | mm | 266 | mm |
| Axial distance Yd of the lateral | 74 | mm | 73 | mm |
| circumferential complex cut in | | | | |
| relation to the midplane XZ | | | | |

| | | |
|---|---|---|
| Ratio Yd/Wt | 29% | 27% |

Measurements of the variations in radius of the tire about the entire circumference thereof, at the ribs delimiting a lateral circumferential complex cut, after 75000 km, reveal maximum amplitudes of local variations in the radius of the tire of 0.7 mm for the reference tire R and 0.3 mm for the tire I according to the invention, i.e. a 43% reduction in amplitude and therefore a significant reduction in irregular wear patterns in this lateral portion after this mileage.

1. A tire for a heavy-duty vehicle comprising a tread intended to come into contact with the ground via a tread surface, comprising cuts delimiting raised elements,
at least one cut being a circumferential complex cut with a midline extending in a circumferential direction (XX′) of the tire, and comprising, when the tire is new, an alternation of external cavities opening onto the tread surface and internal cavities not opening onto the tread surface, two consecutive cavities, respectively an external cavity and an internal cavity, being connected to each other by a connecting channel,
each external cavity having a length (L1) measured along the midline on the tread surface of the tire when new and free,
wherein the length (L1) of each external cavity is equal to at least 1.5% and at most 12% of the external diameter (D) of the tire, as measured on the tire when new and free.

2. The time according to claim 1, wherein the length (L1) of each external cavity is equal to at most 10% of the external diameter (D) of the tire.

3. The tire according to claim 1, having a tread surface portion in contact with flat ground of mean length (Lc) when the new tire is mounted on a recommended rim, inflated to a recommended pressure and subjected to a recommended vertical load, the recommended rim, pressure and vertical load being as defined by the European standards of the European Tire and Rim Technical Organization, wherein the length (L1) of each external cavity is equal to at least 5% and at most 55% of the mean length (Lc) of the tread surface portion in contact with the ground.

4. The tire according to claim 3, wherein the length (L1) of each external cavity is equal to at most 45% of the mean length (Lc) of the tread surface portion in contact with the ground.

5. The tire according to claim 1, wherein each internal cavity has a length (L2) measured along the midline on a radially external section of said internal cavity (8), and wherein the length (L1) of each external cavity is equal to at least 70% and at most 130% of the length (L2) of each internal cavity.

6. The tire according to claim 1, wherein each external cavity has a transverse surface (S1) perpendicular to the midline, and each internal cavity has a transverse surface (S2) perpendicular to the midline, and wherein the transverse surface (S1) of each external cavity is equal to at least 50% and at most 150% of the transverse surface (S2) of each internal cavity.

7. The tire according to claim 6, in which the transverse surface (S1) of each external cavity is equal to at least 80% and at most 140% of the transverse surface (S2) of each internal cavity.

8. The tire according to claim 1, which, tire when new, has an axial tread width (Wt) and a lateral circumferential complex cut, the midline of which is positioned at an axial distance (Yd) from a median circumferential plane (XZ) of the tire, splitting the tire into two symmetrical portions, wherein the axial distance (Yd) of the lateral circumferential complex cut is equal to at least 25% and at most 45% of the axial tread width (Wt).
